(19) United States
(12) Patent Application Publication
(10) Pub. No.: US 2025/0334901 A1
(43) Pub. Date: Oct. 30, 2025

(54) OPTICAL SCANNING APPARATUS AND IMAGE FORMING APPARATUS

(71) Applicant: CANON KABUSHIKI KAISHA, Tokyo (JP)

(72) Inventors: HIROYUKI YAMANO, Kanagawa (JP); TETSUYA NISHIGUCHI, Kanagawa (JP)

(21) Appl. No.: 19/174,209

(22) Filed: Apr. 9, 2025

(30) Foreign Application Priority Data
Apr. 24, 2024 (JP) 2024-070507

(51) Int. Cl. G03G 15/043; B41J 2/47; G02B 26/12; G03G 15/04

(52) U.S. Cl. CPC G03G 15/0435; B41J 2/471; G02B 26/12; G03G 15/04036

(57) ABSTRACT

An optical scanning apparatus is disclosed that includes a light source, a deflector including a rotatable polygonal mirror configured to deflect laser light emitted from the light source, a lens configured to focus the deflected laser light, and an optical box configured to contain the deflector and the lens, with the optical box including a plurality of reference surfaces serving as an attaching surface to an image forming apparatus, and a plurality of planes arranged behind the plurality of reference surfaces along an axis of rotation of the rotatable polygonal mirror, and the axis of the rotation being parallel to the plurality of reference surfaces.

### BACKGROUND

### Field

The present disclosure relates to an optical scanning apparatus mounted on an electrophotographic image forming apparatus such as a copying machine and a printer, and an image forming apparatus including the optical scanning apparatus.

### Related Art

As a method for reducing costs of image forming apparatuses, commonly using a housing (optical box) of an optical scanning apparatus for different types of image forming apparatuses can be considered. Japanese Patent Application Laid-open No. 2004-21156 discusses using a laser scanner with a common housing for both a monochrome printer and a color printer.

However, in a case where the types of the image forming apparatuses are different, positional relationships between photoconductive drums in the image forming apparatuses and optical scanning apparatuses may differ. Due to this difference, there occurs an issue when the image forming apparatuses are assembled.

FIGS. 15A and 15B are cross-section views and FIGS. 16A and 16B are perspective views illustrating a process of assembling an optical scanning apparatus 201 with a common housing. FIGS. 15A and 16A illustrate a first type of image forming apparatuses 210 and FIGS. 15B and 16B illustrate a second type of image forming apparatuses 220. For conciseness, FIGS. 15A, 15B, 16A, and 16B focus on a support member 202 of each of the first and second image forming apparatuses 210 and 220 supporting the optical scanning apparatus 201, the optical scanning apparatus 201, and a photoconductive drum 203. The positional relationship in a vertical direction between the photoconductive drum 203 and the optical scanning apparatus 201 in the second image forming apparatus 220 is opposite to that of the first image forming apparatus 210.

When the first image forming apparatus 210 is assembled in a manufacturing line, the optical scanning apparatus 201 is attached to the support member 202 of the first image forming apparatus 210 from above the first image forming apparatus 210. The housing of the optical scanning apparatus 201 is provided with positioned portions PB, and the support member 202 is provided with positioning portions PH. On the other hand, when the second image forming apparatus 220 is assembled in the manufacturing line, the optical scanning apparatus 201 is attached from below the support member 202. Alternatively, the optical scanning apparatus 201 is attached from above the support member 202 in a state where a main body frame with the support member 202 fixed thereto is reversed, i.e. is upside down.

In the case where the optical scanning apparatus 201 is attached from below the support member 202, efficiency of assembly may deteriorate due to an assembly worker having difficulty seeing an attaching position and fixing positions for springs and/or screws. Access to the fixing positions is also difficult for the assembly worker because the working space is small. In the case where the main body frame of the second image forming apparatus 220 is reversed upside down, the man-hours increase by the man-hours for the work, leading to increased costs.

### SUMMARY

The present disclosure is directed to an optical scanning apparatus mountable on different types of image forming apparatuses, to reduce costs, and to increase assembly efficiency.

An aspect of the present disclosure provides an optical scanning apparatus that includes a light source, a deflector including a rotatable polygonal mirror configured to deflect light emitted from the light source, a lens configured to focus the deflected light, and an optical box configured to contain the deflector and the lens, with the optical box including a plurality of reference surfaces serving as an attaching surface to an image forming apparatus, and a plurality of planes arranged behind the plurality of reference surfaces along an axis of rotation of the rotatable polygonal mirror, the axis of rotation being parallel to the plurality of reference surfaces.

Further features of the present disclosure will become apparent from the following description of exemplary embodiments with reference to the attached drawings.

### BRIEF DESCRIPTION OF THE DRAWINGS

FIG. 1 is a cross-section view of a first image forming apparatus.

FIG. 2 is a perspective view of a front side of an optical scanning apparatus.

FIG. 3 is a perspective view of a back side of the optical scanning apparatus.

FIGS. 4A and 4B are enlarged views of respective portions of FIGS. 2 and 3.

FIG. 5 is a plan view of the front side of the optical scanning apparatus.

FIG. 6 is a plan view of the back side of the optical scanning apparatus.

FIG. 7 is a perspective view of a main body frame of the first image forming apparatus.

FIG. 8 is a perspective view illustrating a state where a scanner unit is attached to the main body frame of the first image forming apparatus.

FIG. 9 is a cross-section view illustrating the state where the scanner unit is attached to the main body frame of the first image forming apparatus.

FIG. 10 is a perspective view of a main body frame of a second image forming apparatus.

FIG. 11 is a perspective view illustrating a state where the scanner unit is attached to the main body frame of the second image forming apparatus.

FIG. 12 is a cross-section view illustrating the state where the scanner unit is attached to the main body frame of the second image forming apparatus.

FIG. 13 is a perspective view of a scanner unit and a main body frame of a first image forming apparatus according to a second exemplary embodiment.

FIG. 14 is a perspective view of the scanner unit and a main body frame of a second image forming apparatus according to the second exemplary embodiment.

FIGS. 15A and 15B are cross-section views illustrating a state where a scanner unit is attached to different types of image forming apparatuses.

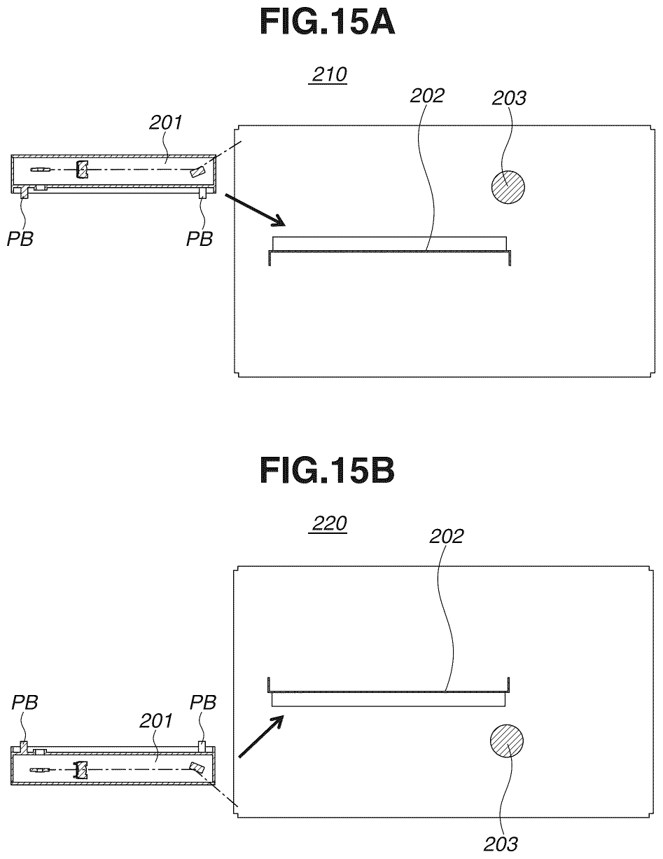

FIG. 16A and 16B are perspective views illustrating the state where the scanner unit is attached to the different types of the image forming apparatuses.

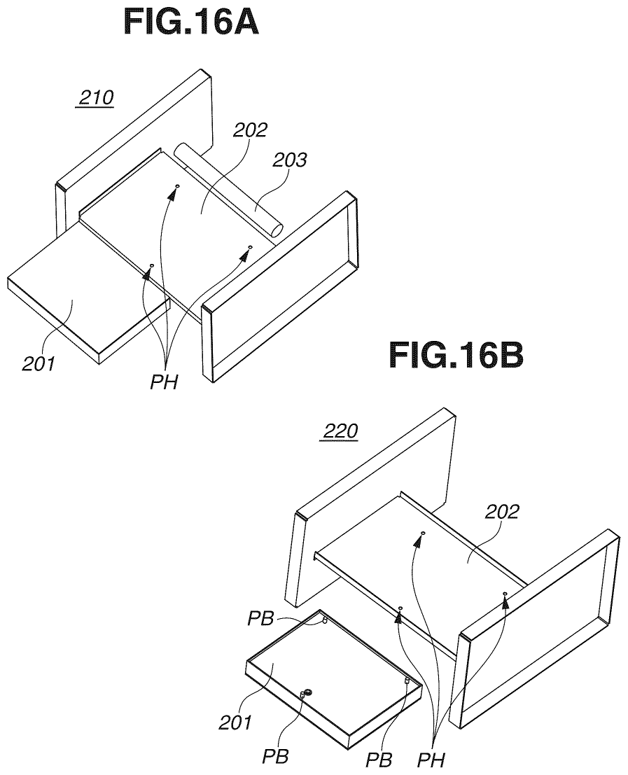

### DETAILED DESCRIPTION

With reference to the attached drawings, exemplary embodiments of the present disclosure will be described in detail, as examples.

### Image Forming Apparatus

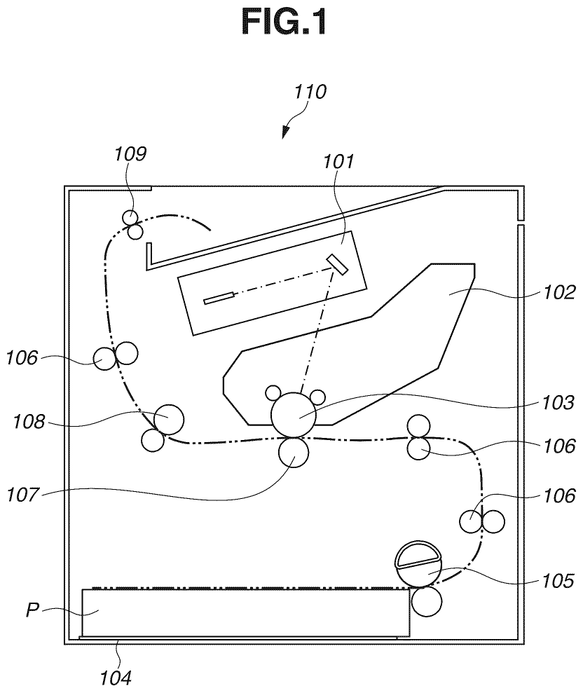

FIG. 1 is a cross-section view illustrating a first image forming apparatus 110 including an optical scanning apparatus (scanner unit) 101 according to a first exemplary embodiment. Hereinbelow, a laser beam printer is described as an example of the first image forming apparatus 110.

The optical scanning apparatus 101 scans a photoconductive drum (photoconductive member) 103 built in a process cartridge 102 with a laser beam corresponding to image information. An electrostatic latent image formed on the photosensitive drum 103 by this scan is developed by a developing device mounted on the process cartridge 102, to form a toner image on the photosensitive drum 103. The process cartridge 102 is a cartridge including the photosensitive drum 103, and a charging device and the developing device serving as process units acting on the photosensitive drum 103, in an integrated manner.

Recording media (medium) P stacked on a stacking plate 104 are separated and fed by a feed roller 105 one by one, and further conveyed by an intermediate roller 106 to the downstream side. A toner image formed on the photosensitive drum 103 is transferred onto the conveyed recording medium P by a transfer roller 107. The recording medium P with the unfixed toner image formed thereon is further conveyed toward the downstream side, and the toner image is fixed onto the recording medium P by a fixing device 108 including a heating member therein.

Then, the recording medium P is discharged outside the first image forming apparatus 110 by a discharge roller 109.

In the present exemplary embodiment, the charging device and the developing device serving as the process units acting on the photosensitive drum 103 are included in the process cartridge 102 in the integrated manner with the photosensitive drum 103, but each of the process units may be configured separately from the photosensitive drum 103.

### Optical Scanning Apparatus

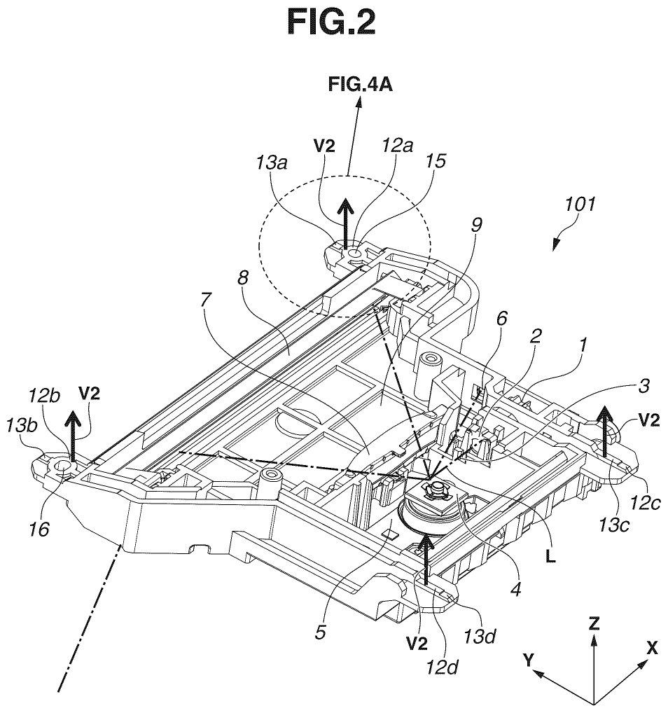

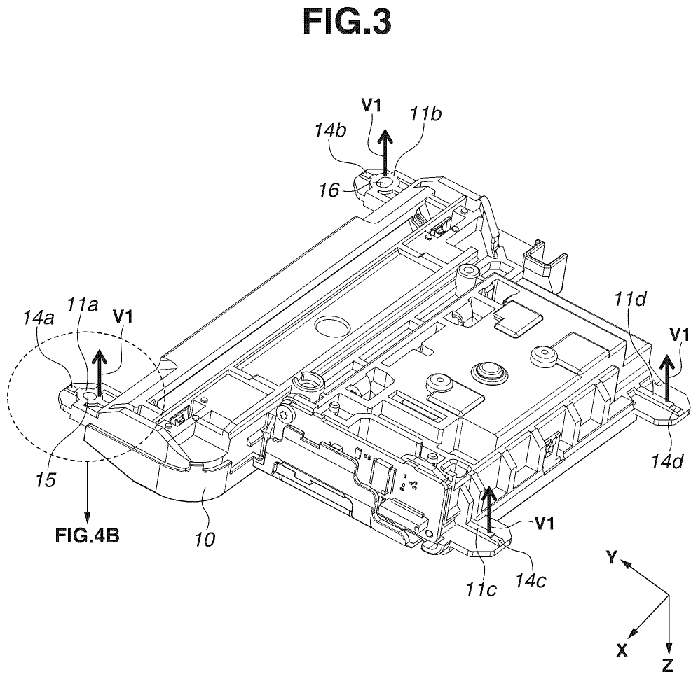

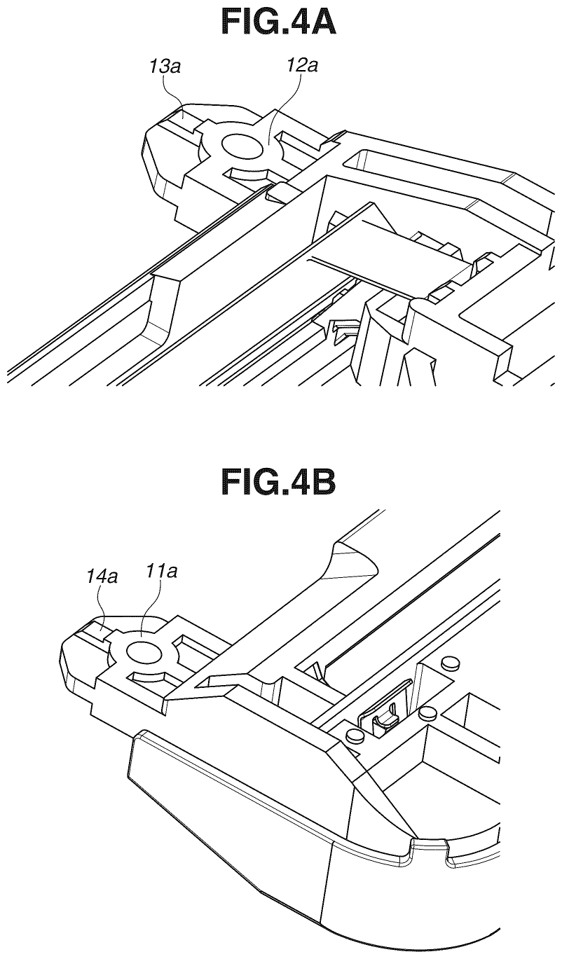

FIGS. 2 and 3 are perspective views illustrating a front side and a back side of the optical scanning apparatus 101, respectively. FIGS. 4A and 4B are enlarged views of respective portions of FIGS. 2 and 3. A Z direction is a direction of an axis of rotation of a rotational shaft of a rotatable polygon mirror 4. For the convenience of description, in FIG. 2, a cover member 10 covering an opening of the optical scanning apparatus 101 is not illustrated.

The optical scanning apparatus 101 includes a laser unit (light source) 1, a deflector 5, an fθ lens 7, an optical box 9 containing a folding mirror 8, and the cover member 10 covering the opening of the optical box 9. Inside the optical box 9, the laser unit 1, an anamorphic collimator lens 2, an aperture stop 3, and the deflector 5 including the rotatable polygon mirror 4, a signal detection sensor 6, the fθ lens 7 (scanning lens), and the folding mirror 8 are contained.

The laser unit 1 includes a semiconductor laser diode for emitting a laser beam

L. The anamorphic collimator lens 2 is formed by integrally molding a collimator lens and a cylindrical lens. The deflector 5 includes the rotatable polygon mirror 4 for deflecting and scanning the laser beam L emitted from the laser unit 1, and a motor for rotationally deriving the rotatable polygon mirror 4.

The laser beam L emitted from the laser unit 1 is converted by the anamorphic collimator lens 2 into approximately parallel light or convergent light in a main-scanning direction, and into convergent light in a sub-scanning direction.

The laser beam L is limited in beam width by passing through the aperture stop 3 to be focused on a reflection surface of the rotatable polygon mirror 4 in a focal line shape elongated in the main-scanning direction. The laser beam L is deflected and scanned by rotating the rotatable polygon mirror 4, and enters the signal detection sensor 6.

The laser beam L (signal) is detected by the signal detection sensor 6, and the detected timing is used as a synchronization detection timing of a writing start position in the main-scanning direction. The laser beam L enters the fθ lens 7. The fθ lens 7 focuses the laser beam L scanned by the deflector 5, on the surface of the photosensitive drum 103. The fθ lens 7 collects the laser beam L to form a spot on the photosensitive drum 103, and to keep a constant scanning speed on the spot. To achieve such characteristics of the fθ lens 7, the fθ lens 7 is formed of an aspherical lens. The laser beam L that has passed through the fθ lens 7 is reflected by the folding mirror 8, output via an exit port of the optical box 9, and focused and scanned on the photosensitive drum 103.

The laser beam L is deflected and scanned by the rotation of the rotatable polygon mirror 4 to perform the main scan on the photosensitive drum 103 with the laser beam L, and the sub-scan is performed by the photosensitive drum 103 being driven to rotate around an axis of a circular cylinder of the photosensitive drum 103. In this way, an electrostatic latent image is formed on the surface of the photosensitive drum 103.

The optical box 9 has first reference surfaces 11a to 11d and second reference surfaces 12a to 12d. The first reference surfaces 11a to 11d and the second reference surfaces 12a to 12d are respectively parallel to each other. When viewed in a Z axis direction, the optical box 9 has first pressed portions 13a to 13d respectively in the vicinities of the back sides of the first reference surfaces 11a to 11d, and second pressed portions 14a to 14d respectively in the vicinities of the back sides of the second reference surfaces 12a to 12d. Further, the optical box 9 has a positioning hole 15 and a detent hole 16.

The positioning hole 15 is a circular hole, and the detent hole 16 is an elongate hole. In the Z axis direction, the first pressed portions 13a to 13d are lower than the second reference surfaces 12a to 12d in height, respectively, and the second pressed portions 14a to 14d are lower than the first reference surfaces 11a to 11d in height, respectively.

The above-described optical scanning apparatus 101 is positioned in the Z axis direction by bringing the first reference surfaces 11a to 11d or the second reference surfaces 12a to 12d into contact with a main body frame (described below) of the first image forming apparatus 110 (or a second image forming apparatus 111). In this way, the optical performance of the optical scanning apparatus 101 in the first image forming apparatus 110 (or the second image forming apparatus 111) can be assured. First vectors V1 respectively with directions perpendicular to the first reference surfaces 11a to 11d and away from the first reference surfaces 11a to 11d point in the −Z direction. Second vectors V2 respectively with directions perpendicular to the second reference surfaces 12a to 12d and away from the second reference surfaces 12a to 12d point in the +Z direction.

The optical scanning apparatus 101 is attached to the first image forming apparatus 110 using the first reference surfaces 11a to 11d and the first pressed portions 13a to 13d. In a case where the optical scanning apparatus 101 is attached to the first image forming apparatus 110, the first reference surfaces 11a to 11d correspond to a plurality of reference surfaces.

The second reference surfaces 12a to 12d are respectively arranged directly on the back sides of the plurality of the first reference surfaces 11a to 11d along the axis of rotation of the rotatable polygon mirror 4, and respectively correspond to a plurality of planes parallel to the plurality of the first reference surfaces 11a to 11d.

The optical scanning apparatus 101 is attached to the second image forming apparatus 111 (described below) using the second reference surfaces 12a to 12d and the second pressed portions 14a to 14d. In the case where the optical scanning apparatus 101 is attached to the second image forming apparatus 111, the second reference surfaces 12a to 12d correspond to a plurality of reference surfaces. The first reference surfaces 11a to 11d are arranged directly on the back sides of the plurality of the second reference surfaces 12a to 12d along the axis of rotation of the rotatable polygon mirror 4, and respectively correspond to a plurality of planes parallel to the plurality of the second reference surfaces 12a to 12d.

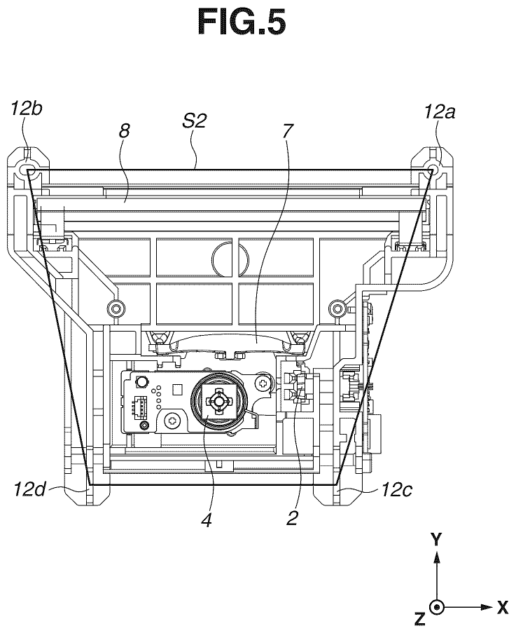

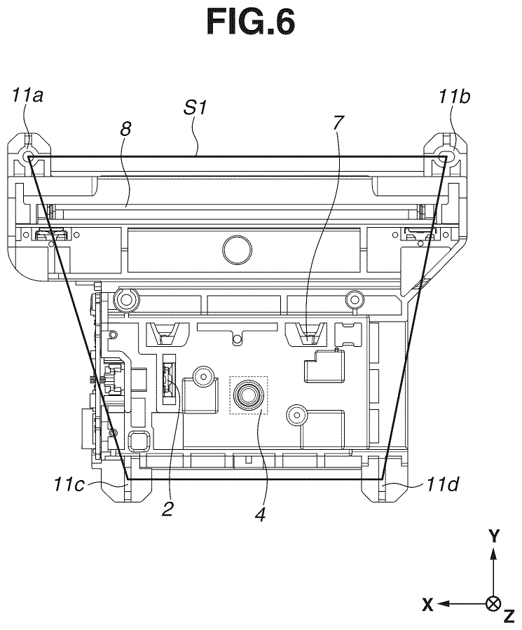

FIG. 5 is a plan view illustrating a front surface (surface of a side from which a surface on which an optical element such as the rotatable polygon mirror 4 is mounted can be seen) of the optical scanning apparatus 101. FIG. 6 is a plan view illustrating a back surface of the optical scanning apparatus 101.

A quadrangle area S1 is an area formed by connecting the first reference surfaces 11a to 11d, and a quadrangle area S2 is an area formed by connecting the second reference surfaces 12a to 12d. When the rotatable polygon mirror 4 is viewed in the direction of the rotational axis, the laser unit 1, the anamorphic collimator lens 2, the rotatable polygon mirror 4, the fθ lens 7, and the folding mirror 8 are disposed inside the quadrangles areas S1 and S2.

A method of attaching the optical scanning apparatus 101 to the first image forming apparatus 110 will be described now. For the convenience of description, in the drawings to be referred to below, from among the components of the first image forming apparatus 110 described with reference to FIG. 1, components other than the optical scanning apparatus 101, and a main body frame 17 and the photosensitive drum 103 of the first image forming apparatus 110 are not illustrated.

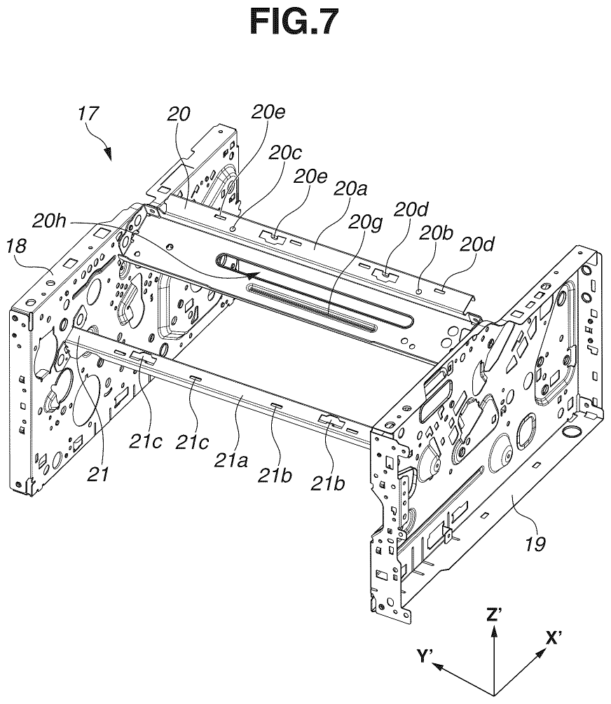

FIG. 7 is a perspective view of the main body frame 17 of the first image forming apparatus 110. The main body frame 17 of the first image forming apparatus 110 includes side plates 18 and 19. Stays 20 and 21 to which the optical scanning apparatus 101 is attached are fixed to the side plates 18 and 19. The stay 20 includes a contact surface 20a, positioning portions 20b and 20c, spring attaching portions 20d and 20e, a through-hole 20h through which a laser beam emitted from the optical scanning apparatus 101 passes, and a drawn portion 20g for increasing the rigidity of the stay 20. The stay 21 includes has a contact surface 21a and spring attaching portions 21b and 21c.

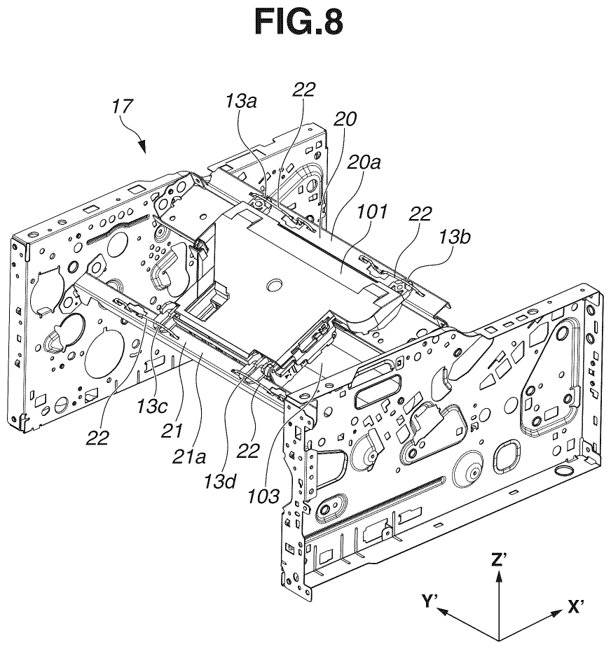

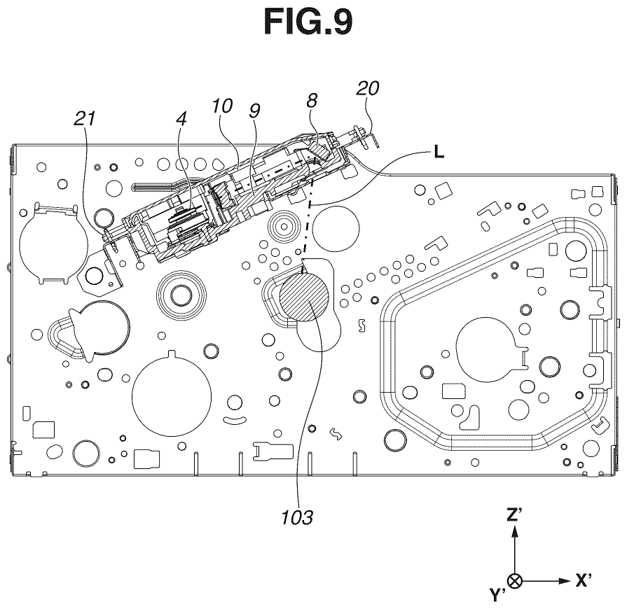

FIG. 8 is a perspective view illustrating a state where the optical scanning apparatus 101 is attached to the main body frame 17. FIG. 9 is a cross-section view illustrating the state where the optical scanning apparatus 101 is attached to the main body frame 17.

The optical scanning apparatus 101 is supported by the stays 20 and 21, with the first reference surfaces 11a to 11d of the optical box 9 being in contact with the corresponding contact surfaces 20a and 21a. The optical scanning apparatus 101 is positioned relative to the main body frame 17, with the positioning portion (protrusion) 20b of the stay 20 being fit into the positioning hole 15 of the optical box 9, and the positioning portion (protrusion) 20c of the stay 20 being inserted into the detent hole 16 of the optical box 9. In this way, the optical box 9 is provided with the positioning hole 15 and the detent hole 16 into which the positioning portions 20b and 20c for positioning the optical scanning apparatus 101 in a planar direction perpendicular to the rotational axis of the rotatable polygon mirror 4 are inserted. The first reference surface 11a and the second reference surface 12a are provided around the positioning hole 15, and the first reference surface 11b and the second reference surface 12b are provided around the detent hole 16. The first reference surfaces 11c and 11d and the second reference surfaces 12c and 12d are provided with no holes. As described above, at least one of the plurality of the first reference surfaces 11a to 11d is provided around the hole or holes.

In this state, wire springs (fixing members for fixing the optical scanning apparatus 101 to the first image forming apparatus 110) 22 are respectively attached to the spring attaching portions 20d and 20e of the stay 20 and the spring attaching portions 21b and 21c of the stay 21, and the respective wire springs 22 press the first pressed portions 13a to 13d of the optical box 9. In this way, the optical scanning apparatus 101 is fixed to the main body frame 17. With this configuration, the laser beam L is focused and scanned on the photosensitive drum 103 disposed below the optical scanning apparatus 101.

A method of attaching the optical scanning apparatus 101 to the second image forming apparatus 111 will be described now. The second image forming apparatus 111 is mainly different from the first image forming apparatus 110 in the configuration of the main body frame, the attaching attitude of the optical scanning apparatus 101, and the arrangement of the photosensitive drum 103. For the convenience of description, in the drawings to be referred to below, from among the components of the second image forming apparatus 111, components other than the optical scanning apparatus 101, and a main body frame 23 and the photosensitive drum 103 of the second image forming apparatus 111 are not illustrated.

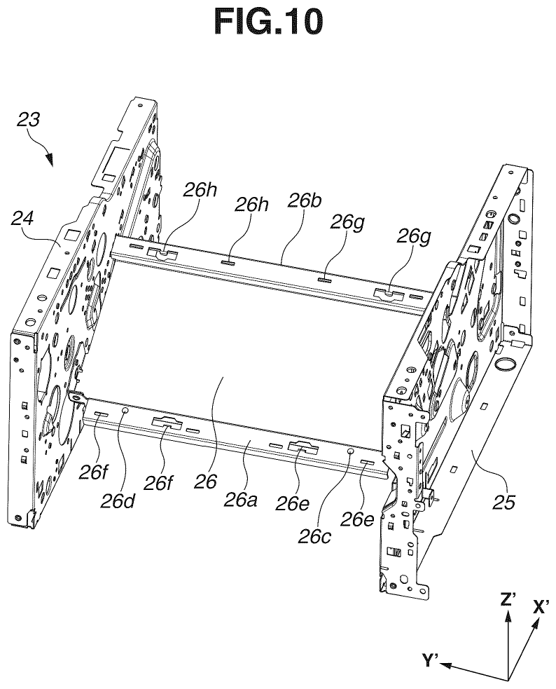

FIG. 10 is a perspective view of the main body frame 23 of the second image forming apparatus 111. The main body frame 23 of the second image forming apparatus 111 includes side plates 24 and 25. A stay 26 to which the optical scanning apparatus 101 is attached is fixed to the side plates 24 and 25. The stay 26 includes contact surfaces 26a and 26b, positioning portions 26c and 26d, and spring attaching portions 26e to 26h. The stay 26 is not provided with the through-hole 20h through which a laser beam passes, which is provided in the stay 20.

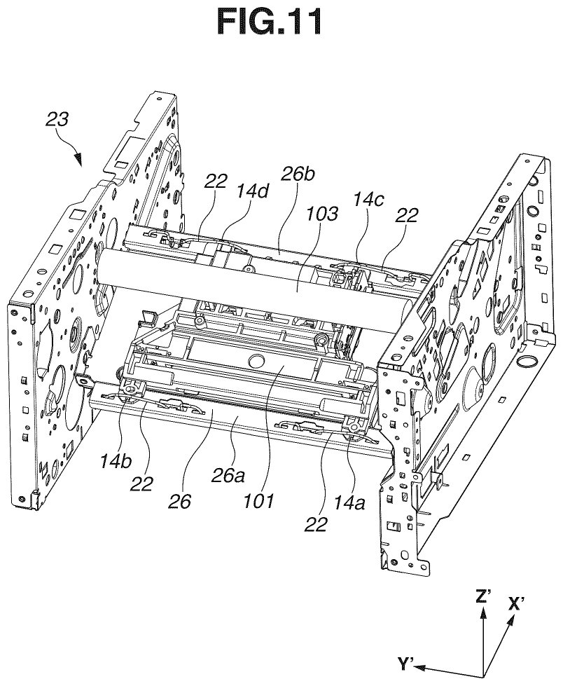

FIG. 11 is a perspective view illustrating a state where the optical scanning apparatus 101 is attached to the main body frame 23.

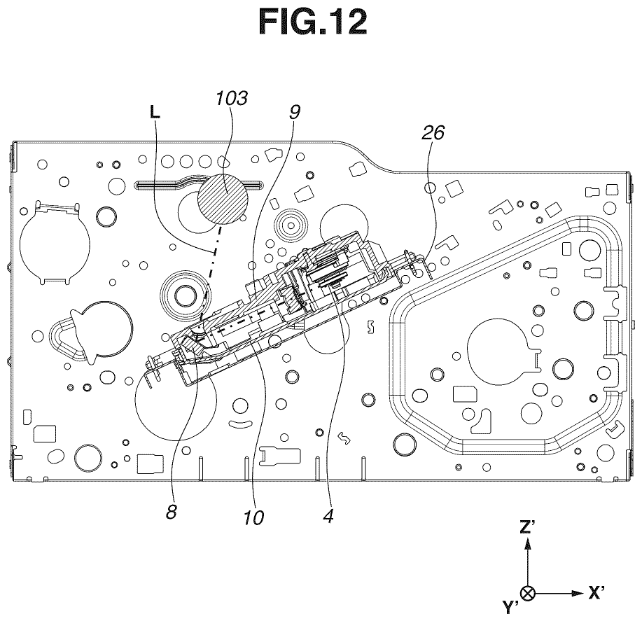

FIG. 12 is a cross-section view illustrating the state where the optical scanning apparatus 101 is attached to the main body frame 23.

When the optical scanning apparatus 101 is attached to the second image forming apparatus 111, the optical scanning apparatus 101 is attached with an attitude in which the optical scanning apparatus 101 is rotated 180° around a Y′ axis relative to the attitude when the optical scanning apparatus 101 is attached to the first image forming apparatus 110.

The optical scanning apparatus 101 is supported by the stay 26 by bringing the second reference surfaces 12a to 12d of the optical box 9 into contact with the corresponding contact surfaces 26a and 26b. The optical scanning apparatus 101 is positioned relative to the second image forming apparatus 111, with the positioning portion 26c of the stay 26 being fit into the positioning hole 15 of the optical box 9, and the positioning portion 26d of the stay 26 being inserted into the detent hole 16 of the optical box 9. In this state, the wire springs 22 are respectively attached to the spring attaching portions 26e to 26h of the stay 26, and the optical scanning apparatus 101 is fixed to the second image forming apparatus 111 by the wire springs 22 respectively pressing the second pressed portions 14a to 14d of the optical box 9. With this configuration, the laser beam L is focused and scanned on the photosensitive drum 103 disposed above the optical scanning apparatus 101.

As described above, the optical scanning apparatus 101 can be attached to the different image forming apparatuses (first image forming apparatus 110 and second image forming apparatus 111) by selectively using the first reference surfaces 11a to 11d and the second reference surfaces 12a to 12d.

At the same time, the optical scanning apparatus 101 can be attached to each of the image forming apparatuses from above the stay regardless of the attitude of the optical scanning apparatus 101 in the image forming apparatus (first image forming apparatus 110 or second image forming apparatus 111) when the optical scanning apparatus 101 is attached thereto. For this reason, the visibility of the attaching positions and fixing positions, and the accessibility to the fixing positions do not change depending on the attitude of the optical scanning apparatus 101 when attached. Thus, the assembly efficiency of the optical scanning apparatus 101 in the image forming apparatus can be improved. The main body frame does not need to be reversed upside down when it is assembled, and thus it is possible to reduce the assembly man-hours, and to reduce the costs.

The first pressed portions 13a to 13d are respectively arranged near the first reference surfaces 11a to 11d, and the second pressed portions 14a to 14d are respectively arranged near the second reference surfaces 12a to 12d, when the optical scanning apparatus 101 is viewed in the Z axis direction. With this configuration, it is possible to prevent the deformation of the optical box 9, the anamorphic collimator lens 2, and the fθ lens 7 due to the pressing force of the wire springs 22. As a result, it is possible to keep the high performance state of the optical characteristics of the scanning apparatus 101.

The laser unit 1, the anamorphic collimator lens 2, the rotatable polygon mirror 4, the fθ lens 7, and the folding mirror 8 are disposed in the quadrangles areas S1 and S2, when the optical scanning apparatus 101 is viewed in the Z axis direction. Thus, it is possible to reduce the vibration amplitude of the optical scanning apparatus 101, due to vibrations from a drive source inside the image forming apparatus. As a result, it is possible to keep the high performance state of the optical characteristics of the optical scanning apparatus 101.

As described above, according to the present exemplary embodiment, it is possible to provide the optical scanning apparatus mountable on the different image forming apparatuses, reduce the costs, and improve the assembly efficiency.

The dimensions, materials, shapes, and relative positions of the components described in the exemplary embodiments are not intended to limit the range of the described examples unless otherwise specifically noted, because they are appropriately changed depending on the configuration of the apparatus to which the present disclosure is applied, and various conditions. More specifically, in the present exemplary embodiment, the four first reference surfaces and the four second reference surfaces are provided, but the number of references surfaces is not limited to four, and in a case where two, three, or five or more reference surfaces are provided, the similar effects can be achieved. In the present exemplary embodiment, the first vectors V1 and the second vectors V2 point in opposite directions along the Z axis, but the directions are not limited to those in the example, and if Z axis direction components of the first vectors V1 and the second vectors V2 are opposite in direction, the similar effects can be achieved.

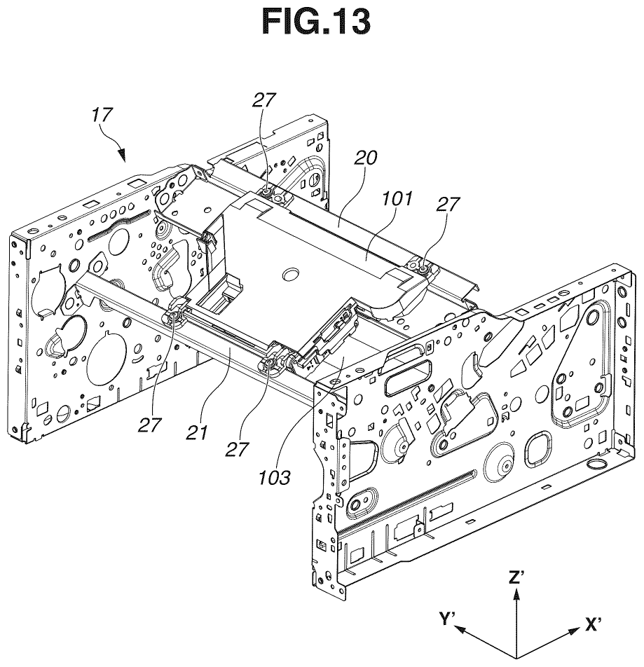

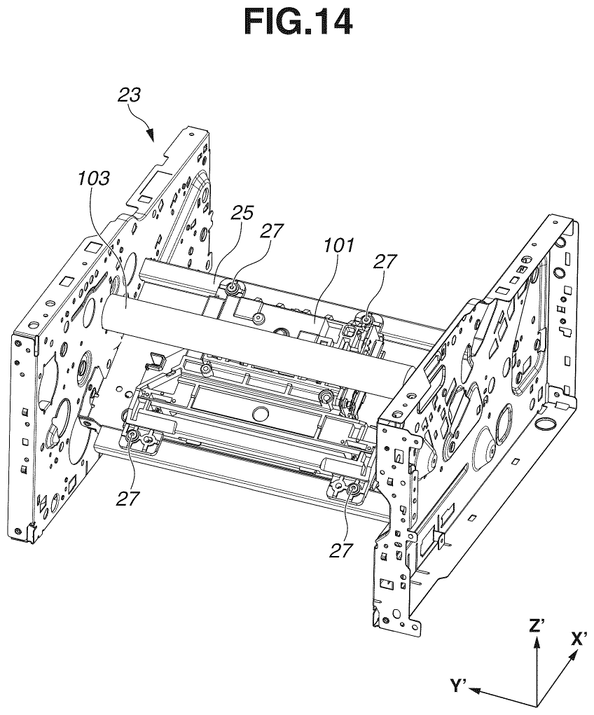

FIG. 13 is a perspective view of a scanner unit and a main body frame of a first image forming apparatus according to a second exemplary embodiment. FIG. 14 is a perspective view of the scanner unit and a main body frame of a second image forming apparatus according to the second exemplary embodiment. Functions and shapes similar to those of the first exemplary embodiment are assigned the same symbols, and description thereof are omitted.

In the present exemplary embodiment, instead of using the wire springs 22 as described in the first exemplary embodiment, screws 27 are used to attach the optical scanning apparatus 101.

In the optical box 9, the first pressed portions 13a to 13d are respectively coplanar

with the second reference surfaces 12a to 12d, and the second pressed portions 14a to 14d are respectively coplanar with the first reference surfaces 11a to 11d. The first reference surfaces 11a to 11d are directly opposed respectively to the first pressed portions 13a to 13d, and the second reference surfaces 12a to 12d are directly opposed respectively to the second pressed portions 14a to 14d. Also with this configuration, effects similar to those according to the first exemplary embodiment described above can be achieved. In addition, since the reference surfaces and the pressed portions are directly opposed with each other, it is possible to more effectively reduce the deformation of the optical box 9 due to the pressing force of the screws 27. As a result, it is possible to prevent the deterioration of the optical performance of the optical scanning apparatus 101.

In contrast to the wire springs 22 produced individually to match the shapes of the pressed portions, it is possible to achieve low costs by using the generic screws 27. Further, since the attaching work of the screws 27 to the main body frame is easier than that of the wire springs 22, low costs can be achieved by reducing the assembly man-hours. Further, by increasing the pressing force of the generic screws 27 to be larger than that of the wire springs 22, it is possible to efficiently reduce the risk of the optical scanning apparatus 101 dropping from the positioning portion, caused by an excessive shock when the image forming apparatus is transported.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-070507, filed Apr. 24, 2024, the entire content of which is incorporated herein by reference.

What is claimed is:

1. An optical scanning apparatus comprising:
a light source;
a deflector including a rotatable polygonal mirror configured to deflect light emitted from the light source; and
a lens configured to focus the deflected light; and
an optical box configured to contain the deflector and the lens,
wherein the optical box includes a plurality of reference surfaces serving as an attaching surface to an image forming apparatus, and a plurality of planes arranged behind the plurality of reference surfaces along an axis of rotation of the rotatable polygonal mirror, the axis of the rotation being parallel to the plurality of reference surfaces.

2. The optical scanning apparatus according to claim 1, wherein a rotation shaft of the rotatable polygonal mirror and the lens are disposed in an area formed by connecting edges of the plurality of reference surfaces and an area formed by connecting the plurality of planes, viewed in a direction of the rotational axis.

3. The optical scanning apparatus according to claim 1, further comprising a pressed portion configured to be pressed by a fixing member configured to fix the optical scanning apparatus to the image forming apparatus at a vicinity of each of the plurality of reference surfaces of the optical box.

4. The optical scanning apparatus according to claim 3, wherein the optical box is provided with a hole into which a positioning portion is inserted, with at least one of the plurality of reference surfaces being provided around the hole.

5. The optical scanning apparatus according to claim 4, wherein the positioning portion is configured to determine a position of the optical scanning apparatus relative to a plane perpendicular to the rotational axis.

6. An image forming apparatus configured to form a toner image on a recording medium, the image forming apparatus comprising:
a photosensitive member; and
the optical scanning apparatus according to claim 1 configured to scan the photosensitive member with a laser beam corresponding to image information.
